(19) United States
(12) Patent Application Publication
(10) Pub. No.: US 2024/0275495 A1
(43) Pub. Date: Aug. 15, 2024

(54) Integrated Photonic Chip System for Distributed Secure Quantum Information Processing

(71) Applicant: National Innovation Institute of Defense Technology, Academy of Military Sciences PLA China, Beijing (CN)

(72) Inventors: Xiaogang QIANG, Beijing (CN); Chao WANG, Beijing (CN)

(21) Appl. No.: 18/289,748

(22) PCT Filed: Sep. 27, 2022
(86) PCT No.: PCT/CN2022/121832

§ 371 Date: Nov. 6, 2023

(30) Foreign Application Priority Data
Sep. 28, 2021 (CN) 202111145661.X

(51) Int. Cl. H04B 10/70; H04J 14/02

(52) U.S. Cl. CPC H04B 10/70; H04J 14/02

(57) ABSTRACT

The invention provided is an integrated photonic chip system for distributed secure quantum information processing. This system includes a server integrated photonic quantum chip and a client integrated photonic quantum chip. The server integrated photonic quantum chip includes: a configurable entangled multi-photon source, configured to generate a plurality of photons and respectively output the photons to a server linear optical network and a client linear optical network according to wavelengths; the server linear optical network, configured to prepare an initial state for the photons outputted by a wavelength division multiplexer, perform unitary transformation and linear combination, perform beam combination, and perform projective measurements on the photons that have been subjected to beam combination; and the client integrated photonic quantum chip, configured to transmit the coefficient of linear terms through quantum teleportation, so as to perform linear combination on each item of unitary transformation in the server integrated photonic quantum chip. A server cannot know a specific computation task of a client, but can inform the client of a result through a classical channel after one computation is completed. By using the technical solution of the embodiments of the present disclosure, the computation privacy of the clients is protected.

### CROSS-REFERENCE TO RELATED APPLICATION

The present disclosure is based upon and claims priority to Chinese Patent Application No. CN202111145661.X filed on Sep. 28, 2021, and entitled “Integrated Photonic Chip System for Distributed Security Quantum Information Processing”, the disclosure of which is hereby incorporated by reference in its entirety.

### TECHNICAL FIELD

The present disclosure relates to the technical field of quantum computation, and in particular, to an integrated photonic chip system for distributed secure quantum information processing.

### BACKGROUND

Quantum computation is a new computation approach that follows the laws of quantum mechanics by regulating quantum information processing units, that is, qubits, to perform computation. Due to the superposition, interference and entanglement properties of quantum, quantum computation has natural parallelism capability and large information storage capacity, which introduces a huge potential that is unmatched by classical computation, and has a huge application potential in many fields such as integer factorization, database search, and chemical molecular simulation.

A linear optical system is one of the main physical pathways for realizing quantum computation. The main advantages of the linear optical system include the following: photons have a long coherence time and are not susceptible to decoherence under external environmental interference; the photons are easy to achieve high-precision control; and the photons have multiple degrees of freedom, and can be used for encoding high-dimensional quantum state. The photonic quantum chip integrates a lot of discrete linear optical elements, in a thin film form, onto a single semiconductor chip by using integrated photonic technology. Compared with the discrete element optical system, the volume is significantly decreased, and the entire system has better stability and better extendibility. The integrated photonic quantum chip can implement miniaturization and integration of a huge optical platform related to discrete element optical systems, such that the integrated photonic quantum chip is considered as a most effective way to realize large-scale photonic quantum computation.

Implementing a large-scale universal quantum computer is not only technically challenging but also expensive. The main usage pattern of quantum computers in the near future is likely to be similar to that of current supercomputers: quantum computation servers are deployed at a plurality of computing centers, and different clients access quantum computation resources in a certain manner, so as to complete respective computation tasks, that is, we can call this a distributed quantum computation system based on a client-server model. In such a distributed client-server quantum computation model, the security of the task executed by a client is the key issue that should be taken into consideration. The security not only involves the input data and output results, but also includes the security of a client algorithm itself. Currently, there has been much research on quantum security schemes for client data, but the research on the security of the algorithms is still less. Therefore, research on a computation mechanism that encrypts against the client algorithm, enables the client to perform computation tasks on a server, but at the same time makes the algorithm of clients hidden from the server and others, to achieve quantum computation with algorithm security, will have great potential for applications in the fields such as security and secrecy maintaining.

### SUMMARY

The present disclosure provides an integrated photonic chip system for distributed secure quantum information processing, for purpose of solving the security problem of a distributed quantum computation model, so as to protect computation privacy of clients.

An embodiment of the present disclosure provides an integrated photonic chip system for distributed secure quantum information processing. The system includes a client integrated photonic quantum chip and a server integrated photonic quantum chip. After a client and a server are connected through a high-dimensional quantum channel, the client may remotely host a computation task on a quantum server, so as to complete complex quantum computation, which is completed through a linear combination operated by the server; linear coefficients are configured by the client and are hidden from the server; and the server outputs results to the client through a classical channel after an operation is completed, facilitating protection of the computation privacy and encrypted communication of the client.

The integrated photonic chip system for distributed secure quantum information processing provided in the embodiments of the present disclosure includes a client integrated photonic quantum chip and a server integrated photonic quantum chip. The server integrated photonic quantum chip includes: a configurable entangled multi-photon source, including a configurable optical network, N entangled multi-photon sources, and a wavelength division multiplexer, where N is a natural number, and N≥2. By configuring a first phase shifter and a second phase shifter in the configurable optical network to perform interference regulation on a light beam inputted to the configurable optical network and output a plurality of paths of light, a plurality of path entangled photons are generated by the entangled multi-photon sources. The number of the entangled photons generated by each entangled multi-photon source is recorded as P. The wavelength division multiplexer is configured to respectively output, according to wavelengths, the plurality of photons outputted by the configurable entangled multi-photon source to a server linear optical network and the client integrated photonic quantum chip. The server linear optical network is divided into the following three parts: an initial state preparation linear optical network O, connected to the wavelength division multiplexer, formed into corresponding O₁, O₂ . . . O_{P-1} according to the wavelengths of the photons outputted by the wavelength division multiplexer, and configured to prepare an initial state for the photons outputted by the configurable entangled multi-photon source; a unitary operator configuration linear optical network U, correspondingly connected to the initial state preparation linear optical network O, and configured to acquire a linear term coefficient, perform unitary transformation and linear combination, and perform beam combination, recording as U₁⁽ⁱ⁾, U₂⁽ⁱ⁾ . . . U_{P-1}⁽ⁱ⁾ (i=1, 2, . . . N); and a projective measurement linear optical network T, correspondingly connected to the unitary operator configuration linear optical network U, and configured to perform projective measurement on an photonic quantum state after beam combination, recording as T₁, T₂ . . . T_{P-1}. The client integrated photonic quantum chip includes a coefficient configuration linear optical network C, which is connected to the wavelength division multiplexer, and configured to encode paths of the photons outputted by the wavelength division multiplexer, so as to obtain the linear term coefficients, which are recorded as α₁, α₂ . . . α_{N}, and transmit the linear term coefficients through quantum teleportation, to perform linear combination on each item of unitary transformation in the unitary operator configuration linear optical network, so as to obtain a final quantum state result: (Σᵢ₌₁^{N}αᵢU₁⁽ⁱ⁾⊗U₂⁽ⁱ⁾⊗ . . . U_{P-1}⁽ⁱ⁾)O₁⊗O₂⊗ . . . O_{P-1}|0 [symbol] .

According to the integrated photonic chip system for distributed secure quantum information processing provided in the embodiments of the present disclosure, the initial state preparation linear optical network, the unitary operator configuration linear optical network, the projective measurement linear optical network, and the coefficient configuration linear optical network all belong to universal linear optical networks.

According to the integrated photonic chip system for distributed secure quantum information processing provided in the embodiments of the present disclosure, the configurable entangled multi-photon source, the initial state preparation linear optical network, the unitary operator configuration linear optical network, the projective measurement linear optical network, and the coefficient configuration linear optical network all achieve path encoding through the first phase shifter and the second phase shifter.

According to the integrated photonic chip system for distributed secure quantum information processing provided in the embodiments of the present disclosure, the configurable optical network of the configurable entangled multi-photon source includes a log₂ N-level Mach-Zehnder interferometer, which is arranged in the form of a binary tree, that is, each output port of the previous level Mach-Zehnder interferometer is connected to an input port of the next level Mach-Zehnder interferometer, and a 2^{┌log}^{₂}^{N┐}th output port of the last level Mach-Zehnder interferometer is connected to a second phase shifter and one entangled multi-photon source; and the Mach-Zehnder interferometer includes a first phase shifter and two multimode interferometers connected to the first phase shifter.

According to the integrated photonic chip system for distributed secure quantum information processing provided in the embodiments of the present disclosure, the first phase shifter and the second phase shifter adjust each path of light by means of external classical control signals, and enable the phase of each path of light before reaching the configurable entangled multi-photon source to be zero.

According to the integrated photonic chip system for distributed secure quantum information processing provided in the embodiments of the present disclosure, the configurable entangled multi-photon source generates the photons with P wavelengths; and the photons with one wavelength are routed to the client integrated photonic quantum chip, and the photons with another P−1 wavelength are respectively correspondingly routed to P−1 groups of initial state preparation linear optical networks (N for each group), where P is a natural number, and P≥2.

According to the integrated photonic chip system for distributed secure quantum information processing provided in the embodiments of the present disclosure, the initial state preparation linear optical network may include a multi-level chain structure.

According to the integrated photonic chip system for distributed secure quantum information processing provided in the embodiments of the present disclosure, the unitary operator configuration linear optical network may be a triangularly distributed optical network structure.

According to the integrated photonic chip system for distributed secure quantum information processing provided in the embodiments of the present disclosure, the projective measurement linear optical network may include an inverted tree structure.

According to the integrated photonic chip system for distributed secure quantum information processing provided in the embodiments of the present disclosure, there are N initial state preparation linear optical networks in each of the P−1 groups of initial state preparation linear optical networks; correspondingly, the unitary operator configuration linear optical networks are divided into P−1 groups, and each group has N unitary operator configuration linear optical networks; there are P−1 projective measurement linear optical networks; and each group of unitary operator configuration linear optical networks is correspondingly connected to one group of initial state preparation linear optical networks and one projective measurement linear optical network.

According to the integrated photonic chip system for distributed secure quantum information processing provided in the embodiments of the present disclosure, the coefficient configuration linear optical network in the client integrated photonic quantum chip may be a simplified triangularly-distributed optical network structure.

According to the integrated photonic chip system for distributed secure quantum information processing provided in the embodiments of the present disclosure, a quantum computation process is realized by providing the configurable entangled multi-photon source on the server integrated photonic quantum chip, generating the path entangled photons and sending the photons to the client integrated photonic quantum chip and the server linear optical network, so as to perform generation of the linear term coefficients, initial state preparation, unitary transformation, linear combination, and projective measurement.

According to the integrated photonic chip system for distributed secure quantum information processing provided in the embodiments of the present disclosure, the integration of photonic chips for quantum computation is realized. Compared with a discrete element optical system, the volume is significantly decreased, and the entire system has better stability and better extendibility because of high integration. Scaling the integrated photonic quantum chip technology can support extensible implementation based on a linear combination scheme of unitary operators, so as to construct a fully programmable distributed quantum computation, thereby achieving photon-based remote quantum information processing.

Further, the integrated photonic chip system for distributed secure quantum information processing in the embodiments of the present disclosure allows, on the basis of a computing protocol, a client to convert a self-task into a linear combination of quantum operations executed by the quantum server. The linear coefficients of these combinations are configured by the client; unitary operation is provided by the server; and the client and the server are connected through the high-dimensional quantum channel.

According to the integrated photonic chip system for distributed secure quantum information processing in the embodiments of the present disclosure, a reliable implementation scheme is provided to protect the computation privacy of the clients, such that the security of quantum computation may be improved, and the problem of the server stealing client information is avoided, thereby facilitating protection of the computation privacy and encrypted communication of the client. Such privacy protection is critical for any client-server model.

### BRIEF DESCRIPTION OF THE DRAWINGS

In order to illustrate the technical solutions in the present disclosure or technical solutions in the prior art more clearly, the drawings used in the technical description of the embodiments will be briefly described below. The drawings in the following descriptions are some embodiments of the present disclosure. Other drawings can be obtained from those skilled in the art according to these drawings without any creative work.

FIG. 1 is a schematic diagram I of an integrated photonic chip system for distributed secure quantum information processing according to an embodiment of the present disclosure.

FIG. 2 is a schematic diagram II of an integrated photonic chip system for distributed secure quantum information processing according to an embodiment of the present disclosure.

FIG. 3 is a schematic flowchart of a quantum computation process in an integrated photonic chip system for distributed secure quantum information processing according to an embodiment of the present disclosure.

FIG. 4 is a schematic diagram of a line realizing the operation of a linear combination according to an embodiment of the present disclosure.

FIG. 5 is a schematic diagram of an optical network structure for initial state preparation according to an embodiment of the present disclosure.

FIG. 6 is a schematic diagram of a triangularly-distributed optical network structure according to an embodiment of the present disclosure.

FIG. 7 is a schematic diagram of an optical network structure for photon beam combination according to an embodiment of the present disclosure.

FIG. 8 is a schematic diagram of an optical network structure for projective measurement according to an embodiment of the present disclosure.

FIG. 9 is a schematic diagram of an integrated photonic chip system for distributed secure quantum information processing in a 2×4-dimensional two-photon entangled state according to an embodiment of the present disclosure.

### DETAILED DESCRIPTION OF THE EMBODIMENTS

In order to make the objectives, technical solutions, and advantages of the present disclosure clearer, the technical solutions of the present disclosure will be clearly and completely described below with reference to the specific embodiments and corresponding drawings of the present disclosure. The described embodiments are only part of the embodiments of the present disclosure, not all the embodiments. Based on the embodiments in the present disclosure, all other embodiments obtained by those of ordinary skill in the art without creative work shall fall within the protection scope of the present disclosure.

The technical solutions provided in each embodiment of the present disclosure are described in detail below with reference to the drawings.

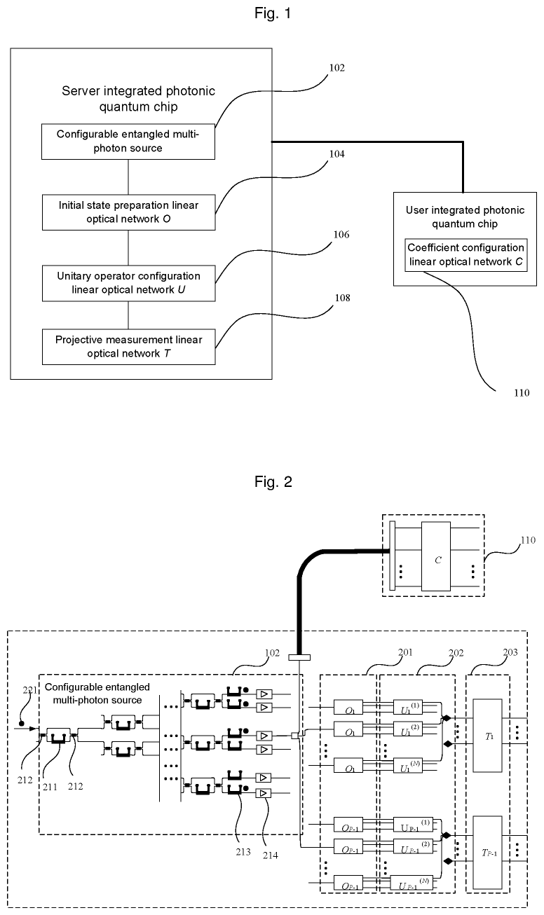

As shown in FIG. 1, an integrated photonic chip system for distributed secure quantum information processing in the embodiments of the present disclosure includes a client integrated photonic quantum chip and a server integrated photonic quantum chip. The server integrated photonic quantum chip and the client integrated photonic quantum chip are connected through a high-dimensional quantum channel. A client prepares linear term coefficients, and the linear term coefficients are hidden from a server. A client task is completed by means of the linear combination operated by the server. The server provides unitary transformation computation. The server outputs results to the client through a classical channel after an operation is completed. The server cannot know the specific task of the client during the entire computation process. The server integrated photonic quantum chip includes a configurable entangled multi-photon source and linear optical network.

The configurable entangled multi-photon source 102 includes are configurable optical network, N entangled multi-photon sources, and a wavelength division multiplexer, where N is a natural number, and N≥2. The configurable optical network is configured to perform interference regulation on a light beam inputted to the configurable optical network, output a plurality of paths of light, and generate a plurality of path-entangled photons through the entangled multi-photon sources. The wavelength division multiplexer is configured to respectively output, according to wavelengths, the plurality of photons outputted by the configurable entangled multi-photon source to a server linear optical network and the client integrated photonic quantum chip.

The server linear optical network is divided into the following three parts.

An initial state preparation linear optical network (O) 104 is connected to the wavelength division multiplexer, formed into corresponding O₁, O₂ . . . O_{P-1} according to the wavelengths of the photons outputted by the wavelength division multiplexer, and configured to prepare an initial state for the photons outputted by the configurable entangled multi-photon source.

A unitary operator configuration linear optical network (U) 106 is correspondingly connected to the initial state preparation linear optical network O, and configured to acquire a linear term coefficient, perform unitary transformation and linear combination, and perform beam combination, recorded as U₁⁽ⁱ⁾, U₂⁽ⁱ⁾ . . . U_{P-1}⁽ⁱ⁾ (i=1, 2, . . . N).

A projective measurement linear optical network (T) 108 is correspondingly connected to the unitary operator configuration linear optical network U, and configured to perform projective measurement on a photonic quantum state after beam combination, recording as T₁, T₂ . . . T_{P-1}.

Specifically, the linear combination refers to a linear combination of unitary transformations realized by different optical networks, projective measurement is to perform spectral decomposition on a Hermitian operator representing an observable measurement on a system Hilbert space into a plurality of measurement operators. The measurement operator is a projection of the Hermitian operator facing toward an eigensubspace generated by a corresponding eigenvalue.

The client integrated photonic quantum chip includes a coefficient configuration linear optical network (C) 110, which is connected to the wavelength division multiplexer, and configured to encode paths of the photons outputted by the wavelength division multiplexer, so as to obtain the linear term coefficients, which are recorded as α₁, α₂ . . . α_{N}, and transmit the linear term coefficients through quantum teleportation, to perform linear combination on each item of unitary transformation in the unitary operator configuration linear optical network, so as to obtain a final quantum state result: (Σᵢ₌₁^{N}αᵢU₁⁽ⁱ⁾⊗U₂⁽ⁱ⁾⊗ . . . U_{P-1}⁽ⁱ⁾)O₁⊗O₂⊗ . . . O_{P-1}|0 [symbol] .

By using the technical solutions of the embodiments of the present disclosure, the distributed arrangement may be performed on the client and the server, such that an entangled state is shared between the client and the server. Therefore, a computation is remotely hosted on a quantum server without disclosing an accurate algorithm to the quantum server. The client's task is completed through the linear combination operated by the server. The linear term coefficients are configured by the client and hidden from the server. The server provides unitary transformation computation. The server outputs the results to the client through a classical channel after an operation is completed, such that the computation privacy of the client is protected during the entire quantum computation process.

In the embodiments of the present disclosure, the quantum server may be referred to as a server.

In the embodiments of the present disclosure, the server integrated photonic quantum chip may further be provided with an integrated photonic source, which is configured to generate a light beam and output the light beam to the configurable optical network. The server integrated photonic quantum chip may further be integrated with a single photon detector, which is configured to detect the photons outputted by the server linear optical network. The single photon detector may be an avalanche photodiode or a superconduction nanowire detector.

An integrated photonic-based quantum chip technology has now achieved greater development. The technology uses a semiconductor micro/nano processing technology to integrate a discrete optical element onto a single chip. Compared to discrete optical elements, it has advantages such as small size, high stability, and strong extendibility, the technology is an effective approach for realizing a large-scale photonic quantum computation system.

The field of integrated photonic quantum chips has been developing rapidly in recent years; and important components required to realize integrated photonic quantum computation have been experimentally verified, including on-chip single photon sources and entangled photon sources, on-chip high-precision quantum state manipulation, and on-chip linear optical networks. On the basis of these basic units or modules, by designing a photonic chip structure, quantum information carriers-photons can be generated, controlled and measured on the single chip, so as to make it possible to realize an integrated, miniaturized, extensible, and programmable quantum computation apparatus.

Scaling the integrated photonic quantum chip technology can support extensible implementation based on a linear combination scheme of unitary operators, so as to construct a fully programmable high-dimensional qubits computing chip, thereby achieving photon-based multi-qubits quantum information processing. In addition, the manufacturing process of the integrated photonic quantum chip such as a silicon-based optical waveguide may be compatible with that of a Complementary Metal Oxide Semiconductor (CMOS). The integrated photonic quantum chip in the embodiments of the present disclosure can be further fused with a traditional CMOS computation chip, so as to design a photonic quantum information processing chip for realizing optoelectronic fusion and hybrid architecture in the future.

As shown in FIG. 2, the interference regulation network of the configurable entangled multi-photon source includes a log₂ N-level Mach-Zehnder interferometer, which is arranged in the form of a “binary tree”, that is, each output port of the previous level Mach-Zehnder interferometer is connected to an input port of the next level Mach-Zehnder interferometer, and a 2^{┌log}^{₂}^{N┐}th output port of the last level Mach-Zehnder interferometer is connected to a second phase shifter and one entangled multi-photon source.

The Mach-Zehnder interferometer is an interferometer, which may be configured to control changes in a relative phase shift of a light beam emitted from a separate light source after the light beam has split into two collimated light beams and passed through different paths and media.

The Mach-Zehnder interferometer includes a phase shifter 211 and two multimode interferometers 212 connected to the phase shifter 211. As shown in FIG. 2, phase shifter 211 is a first phase shifter, and phase shifter 213 is a second phase shifter.

The first-level Mach-Zehnder interferometer of the log₂ N-level Mach-Zehnder interferometer receives an external input light beam 221. The log₂ N-level Mach-Zehnder interferometer forms N paths of light according to the input light beam 221, and outputs the N paths of light to the entangled multi-photon source 214.

Correspondingly, the number of the entangled multi-photon sources included in the configurable entangled multi-photon source 102 is N. The N entangled multi-photon sources may be marked as S₁, S₂, . . . , S_{N}. Each entangled multi-photon source is connected to a second phase shifter. Specifically, the first phase shifter and the second phase shifter adjust each path of light by means of external classical control signals, and enable the phase of each path of light before reaching the configurable entangled multi-photon source to be zero.

As shown in FIG. 2, the server linear optical network includes the initial state preparation linear optical network, the unitary operator configuration linear optical network, and the projective measurement linear optical network.

The initial state preparation linear optical network 201 is connected to the wavelength division multiplexer, formed into corresponding O₁, O₂ . . . O_{P-1} according to the wavelengths of the photons outputted by the wavelength division multiplexer, and configured to prepare an initial state for the photons outputted by the configurable entangled multi-photon source.

The unitary operator configuration linear optical network 202 is correspondingly connected to the initial state preparation linear optical network O, and configured to acquire a linear term coefficient, perform unitary transformation and linear combination, and perform beam combination, recording as U₁⁽ⁱ⁾, U₂⁽ⁱ⁾ . . . U_{P-1}⁽ⁱ⁾ (i=1, 2, . . . N).

The projective measurement linear optical network 203 is correspondingly connected to the unitary operator configuration linear optical network U, and configured to perform projective measurement on a photonic quantum state after beam combination, recording as T₁, T₂ . . . T_{P-1}.

By configuring the phase shifter in the configurable entangled multi-photon source to adjust the phase of each path of light outputted by the interference regulation network to be 0, and in combination with the uniform light beam, the highest efficiency of the entangled photon state generated by the configurable entangled multi-photon source may be achieved. The probability of entangled photons generated by each entangled multi-photon source is 1/\sqrt{N}; and each multi-photon source generates the photons with P different wavelengths.

After passing through the wavelength division multiplexer, the photons are respectively routed to the client integrated photonic quantum chip and entrances of the initial state preparation linear optical network. The initial state preparation linear optical network is configured to prepare an initial state.

Since each multi-photon source generates the photons with P different wavelengths, the photons with the same wavelength are routed to the client integrated photonic quantum chip or the same group of initial state preparation linear optical networks. Therefore, it may be considered that the photons routed to the client integrated photonic quantum chip have the same wavelength, and the photons routed to the initial state preparation linear optical network have P−1 wavelengths. In this way, the number of the initial state preparation linear optical networks may be set to P−1 groups. The P−1 groups of initial state preparation linear optical networks may be marked as O₁, O₂, . . . , O_{M}, . . . , O_{P-1}, where M and P are all natural numbers, and 1≤M≤P−1. There are N initial state preparation linear optical networks in each group. Therefore, the number of the initial state preparation linear optical networks is (P−1)*N.

Correspondingly, there are (P−1)*N unitary operator configuration linear optical networks, which may be divided into P−1 groups, and each group includes N unitary operator configuration linear optical networks. The first group of unitary operator configuration linear optical networks U₁ is correspondingly connected to the first group of initial state preparation linear optical networks O₁; the second group of unitary operator configuration linear optical networks U₂ is correspondingly connected to the second group of initial state preparation linear optical networks O₂; and the (P−1)th group of unitary operator configuration linear optical networks U_{P-1} is correspondingly connected to the (P−1)th group of initial state preparation linear optical networks O_{P-1}.

Specifically, the (P−1)*N unitary operator configuration linear optical networks may be respectively marked as U₁⁽¹⁾, U₁⁽²⁾ . . . U₁^{(N)}, U₂⁽¹⁾, U₂⁽²⁾ . . . U₂^{(N)} . . . , U_{P-1}⁽¹⁾, U_{P-1}⁽²⁾ . . . U_{P-1}^{(N)}.

There are P−1 projective measurement linear optical networks, and each projective measurement linear optical network corresponds to one group of O and U. The P−1 projective measurement linear optical networks may be marked as T₁, T₂, . . . T_{M}, . . . T_{P-1}, where 1≤M≤P−1, and each T_{M} is provided with t ports.

In the related techniques of mathematics, the unitary transformation is the transformation that retains an inner product, and an inner product of two vectors before the unitary transformation is equal to an inner product after conversion. The unitary transformation is the transformation that is done by using unitary operators, including the transformation on a basic vector and the transformation on an operator. It may be considered that, the unitary transformation is the isomorphism between two Hilbert spaces.

Specifically, if a certain unitary matrix V_{T} is about to be realized, V_{T} here may be represented as V_{T}=αⱼUⱼ,(j=0, 1, 2 . . . n−1), where Uⱼ is a gate acting on a d-dimensional target (T) subspace, and αⱼ is a complex coefficient, meeting Σⱼ₌₀ⁿ⁻¹|αⱼ|²=1. When a controlled Uⱼ gate is available, the V_{T} may be achieved in a probabilistic manner. The αⱼ is encoded as an initial state |ϕ [symbol] _{C}=Σⱼ₌₀ⁿ⁻¹αⱼ|j [symbol] _{C} controlled by k qubits, where n=2^{k}, and j marks a computational basis; and a quantum circuit succeeds when the final measurement of all controlled qubits in the computational basis is 0. The controlled qubits may be acted on unitary qubits more simply by transferring the partial state of a target qubit to an extended Hilbert space. In the embodiments of the present disclosure, a linear combination quantum circuit may be achieved by using a technology based on an extended computational Hilbert space.

Any quantum unitary operation may be decomposed in principle as a linear sum of basic operations. For example, any two qubits unitary operations may be rewritten by using the KAK decomposition of Cartan, and then are converted into a linear combination of four linear terms; and each linear term is a tensor product of two single qubit gates. In addition, a Cartan decomposition method allows n quantum unitary operations to be reconstructed as the linear combination of the tensor products of n single qubit gates. In order to realize the linear combination of quantum operations, coherent control needs to be added for any unknown quantum operation. The technology is based on a gate extended by a logical Hilbert space for computation.

According to needs, after passing through the wavelength division multiplexer, the photons generate corresponding multi-photon path entangled states at the entrances of the initial state preparation linear optical network according to different wavelengths. Each photon in the Mth group of photons |M [symbol] ₁|M [symbol] ₂ . . . |M [symbol] _{N} with the same wavelength is routed to the initial state preparation linear optical network O_{M}, so as to generate the initial state.

The Mth group of photons with the same wavelength is routed to the unitary operator configuration linear optical networks U_{M}⁽¹⁾, U_{M}⁽²⁾, . . . , U_{M}^{(N)}, so as to complete unitary transformation and linear combination. The linear term coefficients are recorded as α₁, α₂, . . . , α_{N}, and are provided by the client integrated photonic quantum chip through quantum teleportation. Beam combination is performed on the light path, and a final quantum state result may be obtained after beam combination: (Σᵢ₌₁^{N}αᵢU₁⁽ⁱ⁾⊗U₂⁽ⁱ⁾⊗ . . . U_{P-1}⁽ⁱ⁾)O₁⊗O₂⊗ . . . O_{P-1}|0 [symbol] . The projective measurement linear optical network 203 is configured to perform projective measurement on the photonic quantum state after beam combination.

The initial state preparation linear optical networks, the unitary operator configuration linear optical networks, and the projective measurement linear optical networks are all a plurality of universal linear optical networks that may realize t-dimensional unitary transformations.

An embodiment of the present disclosure provides an integrated photonic chip system for distributed secure quantum information processing. As shown in FIG. 2, the chip system further includes the client integrated photonic quantum chip. A coefficient configuration linear optical network C is connected to the wavelength division multiplexer of the server integrated photonic quantum chip, and is configured to receive the photons respectively outputted by the wavelength division multiplexer according to the wavelengths, and transmit the linear term coefficients to the server through quantum teleportation after the photons are processed. The server linear optical network prepares an initial state for the photons outputted by the wavelength division multiplexer, and acts, according to the client linear optical network, the coefficients regarding linear terms transmitted through quantum teleportation on each item of a linear combination of unitary operators; and then beam combination is performed on the photons after the linear combination, and projective measurement is performed. Therefore, the client task is completed by means of the linear combination operated by the server.

The coefficients about linear terms are obtained by encoding, by the client linear optical network, the paths of the photons outputted by the wavelength division multiplexer. The photons are the plurality of path entangled photons generated by the configurable entangled multi-photon source of the server. The plurality of paths of light are obtained by performing, by the configurable entangled multi-photon source according to the interference regulation network of the server, interference regulation on the light beam inputted to the interference regulation network, and then are outputted.

In the embodiments of the present disclosure, the integrated photonic chip system for distributed secure quantum information processing is formed by an integrated photonic quantum chip on a server side and an integrated photonic quantum chip on the client side. By using an integrated optical waveguide technology, a client may remotely host a computation task on the quantum server, so as to realize a complex quantum computation, without disclosing a specific algorithm to the quantum server.

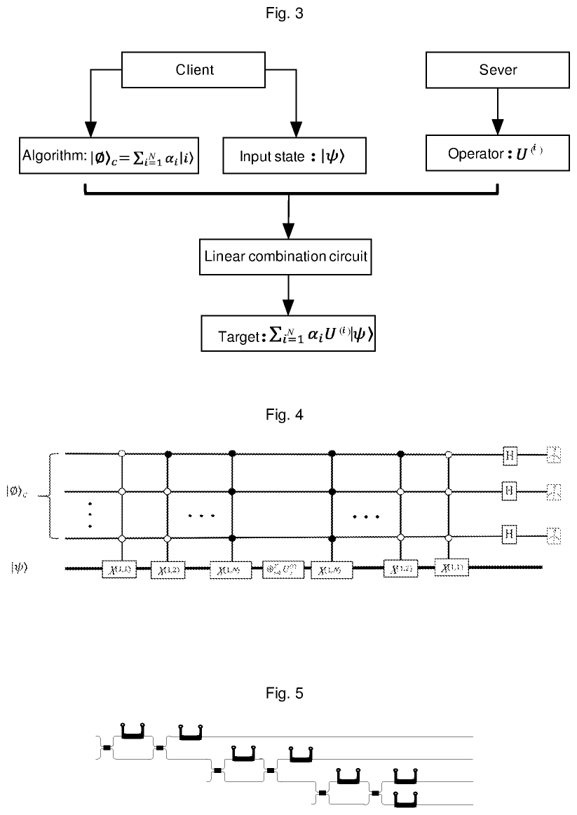

As shown in FIG. 3, in the embodiments of the present disclosure, the client provides an algorithm and an input state, and the server provides an operator. Herein, the algorithm may be |ϕ [symbol] _{c}=Σᵢ₌₁^{N}αᵢ|i [symbol] , the input state may be |ψ [symbol] , and the operator may be U⁽ⁱ⁾. The algorithm, the input state and the operator are inputted to a linear combination quantum circuit shown in FIG. 4 for processing, so as to obtain a target. |ψ [symbol] is encoded in the first d-dimensional subspace in a n*d-dimensional subspace, and X^{(1,j)} represents an exchange operation of basic elements corresponding to the first subspace and the jth subspace. These operations are controlled by a qubit in the client. As shown in FIG. 3, a result may be Σᵢ₌₁^{N}αᵢU⁽ⁱ⁾|ψ [symbol] .

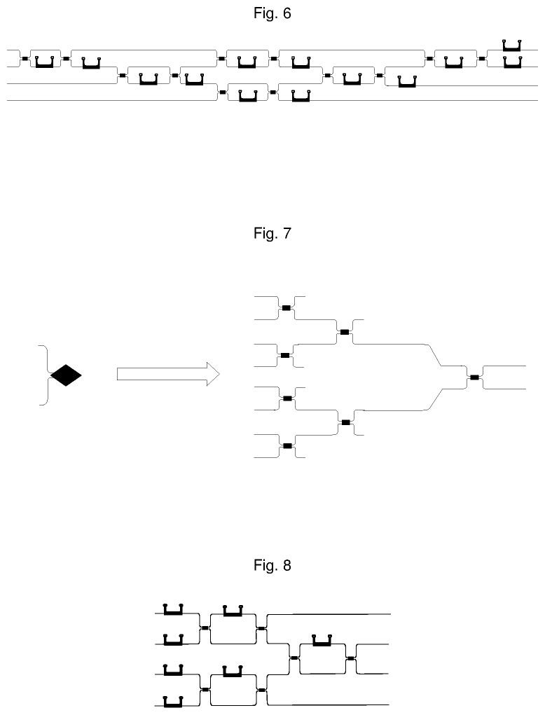

In the embodiments of the present disclosure, a server initial state preparation linear optical network may be a multi-level chain structure shown in FIG. 5. The unitary operator configuration linear optical network includes a triangularly-distributed optical network structure shown in FIG. 6, and includes a beam combination optical network shown in FIG. 7. The projective measurement linear optical network may be an inverted tree structure shown in FIG. 8.

In the embodiments of the present disclosure, the coefficient configuration linear optical network in the client integrated photonic quantum chip may be a simplified triangularly-distributed optical network structure.

The integrated photonic chip system in the embodiments of the present disclosure is the integrated photonic chip system for distributed secure quantum information processing, which can allow, on the basis of a computing protocol, a client to convert a self-task into a linear combination of quantum operations executed by the quantum server. The linear coefficients of these combinations are configured by the client; a unitary operation is provided by the server; and the client and the server are connected through the high-dimensional quantum channel.

An integrated photonic quantum chip in the embodiments of the present disclosure integrates discrete linear optical elements, in a thin film form, onto a single semiconductor integrated chip by using an integrated photonic technology. Compared with the discrete element optical system, the volume is significantly decreased, and the entire system has better stability and better extendibility because of high integration.

Important components required by the integrated photonic quantum chip have been experimentally implemented, respectively, such as on-chip single-photon source and entangled photon source, on-chip wavelength division multiplexer, and on-chip universal linear optical network implementation. On the basis of these integrated chip components, the entangled photons are generated by using an on-chip integrated photon source; the behavior of the photons are controlled by using the linear optical network formed by an on-chip integrated Mach-Zehnder interferometer and a phase controller; and then the photons are detected by means of an on-chip integrated single photon detector. Therefore, the large-scale integrated photonic quantum chip may be designed and used for implementing complex quantum information processing applications.

The integrated photonic quantum chip in the embodiments of the present disclosure respectively acts as the entangled photons between the server and the client on the basis of a path-encoded linear combination scheme of unitary operators, such that a reliable implementation scheme is provided to protect the computation privacy of the client. In addition, the linear combination scheme of unitary operators can realize the separation of a hardware implementation module in quantum computation and a quantum algorithm, so as to build a distributed quantum computation mode of a client-server mode, such that the security of quantum computation may be improved, and the problem of the server stealing client information is avoided, thereby facilitating protection of the computation privacy and encrypted communication of the client. Such privacy protection is critical for any client-server model.

The integrated optical waveguide technology is used in the present disclosure, and compared with a discrete optical element, the integrated optical waveguide technology improves the stability of a quantum optical system.

In the embodiments of the present disclosure, by means of an integrated photonic quantum chip approach, an on-chip path entangled multi-photon source and the universal linear optical network are used cooperatively, so as to build a distributed integrated photonic chip system, including the integrated photonic quantum chip on the server side and the integrated photonic quantum chip on the client side. Specifically, in the embodiments of the present disclosure, different multi-photon multipath entangled states are generated by means of the on-chip path entangled multi-photon source, so as to realize regulation on client-server optimal quantum; different optical unitary transformations are configured by means of the on-chip universal linear optical network, so as to achieve different computation tasks according to needs; and a quantum information processing result is obtained by performing output measurement, so as to achieve universal quantum information computation.

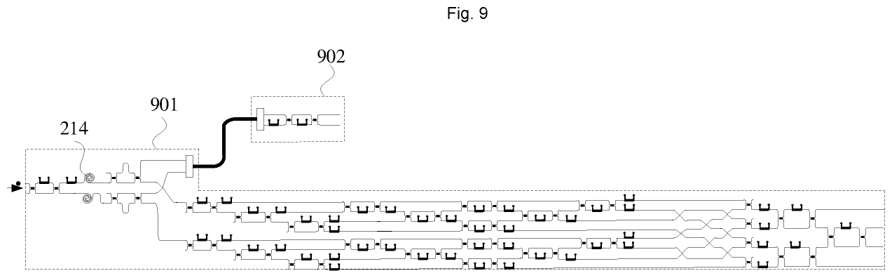

FIG. 9 is a schematic diagram of an integrated photonic chip system for distributed secure quantum information processing in a 2×4-dimensional two-photon entangled state according to an embodiment of the present disclosure. The integrated photonic quantum chip is formed by a server module 901 and a client module 902. The server and client modules achieve transmission by means of a multi-dimensional quantum state. The phase of each path of light maybe 0 by adjusting the Mach-Zehnder interferometer before the entangled multi-photon source. The server module separates signal photons and idler photons generated by the entangled multi-photon source by using the wavelength division multiplexer, and may generate path entangled photon pairs on the integrated photonic quantum chip in combination with a post-selection technology of the photons. After receiving the photons, the client encodes the paths, and configures the coefficient of each item in the linear combination; and the server module achieves the linear combination of unitary operations. All phase shifters in the chip may adjust each path of light by means of the external classical control signals, so as to realize a programmable photonic quantum computation chip.

As shown in FIG. 9, the single photon generates the signal photons and the idler photons by means of the entangled multi-photon source, respectively recording the generated quantum states as |α [symbol] ₐ, |β [symbol] _{b}, |α [symbol] _{c}, and |β [symbol] _{d}; and the phase is adjusted by the Mach-Zehnder interferometer, so as to obtain the maximum entangled state 1/\sqrt{2}(|α [symbol] ₐ|α [symbol] _{c}+|β [symbol] _{b}|⊕ [symbol] ₐ). Dimension extension is performed on two paths of the server module, and 4 dimensions are extended herein. Unitary transformations U⁽¹⁾ and U⁽²⁾ of the linear optical network act on |α [symbol] _{c} and |β [symbol] _{d}. Actually, |α [symbol] _{c} and |β [symbol] _{d} may be represented by using a group of defined bases |0 [symbol] =[1 0 0 0]^{T}, |1 [symbol] =[0 1 0 0]^{T}, |2 [symbol] =[0 0 1 0]^{T}, and |3 [symbol] =[0 0 0 1]^{T}. A state after the action of the unitary transformations U⁽¹⁾ and U⁽²⁾ of a universal optical network is 1/\sqrt{2}(|α [symbol] ₐ⊗U⁽¹⁾|0 [symbol] _{c}+|β [symbol] _{b}⊗U⁽²⁾|0 [symbol] _{d}). A final result is that the client requests the server to perform corresponding operations to complete the computation of a 4-dimensional quantum state, so as to obtain a 4-dimensional quantum state |Ø);|Ø)=(αU⁽¹⁾+βU⁽²⁾)|0 [symbol] and |0 [symbol] is provided by the linear optical network O, the unitary transformations U⁽¹⁾ and U⁽²⁾ are provided by the server, and the linear term coefficients α and β are provided by the client and hidden from the server.

According to the integrated photonic chip system for distributed secure quantum information processing provided in the embodiments of the present disclosure, a quantum computation process is realized by, on the basis of the distributed integrated photonic chip, providing the configurable entangled multi-photon source on the integrated photonic chip, generating the path entangled photons and sending the photons to the client and server linear optical networks, generating the linear term coefficients, and performing linear combination of unitary operators and projective measurement.

The integrated photonic chip system for distributed secure quantum information processing in the embodiments of the present disclosure is to integrate discrete linear optical elements, in a thin film form, onto a semiconductor integrated chip by using an integrated photonic technology. Compared with the discrete element optical system, the volume is significantly decreased, and the entire system has better stability and better extendibility because of high integration.

Further, the integrated photonic chip system for distributed secure quantum information processing in the embodiments of the present disclosure can allow, on the basis of a computing protocol, a client to convert a self-task into a linear combination of quantum operations executed by the quantum server. The linear coefficients of these combinations are configured by the client; a unitary operation is provided by the server; and the client and the server are connected through the high-dimensional quantum channel. It may be seen that, according to the integrated photonic chip system for distributed secure quantum information processing in the embodiments of the present disclosure, a reliable implementation scheme is provided to protect the computation privacy of the clients, such that the security of quantum computation may be improved, and the problem of the server stealing client information is avoided, thereby facilitating protection of the computation privacy and encrypted communication of the client. Such privacy protection is critical for any client-server model.

Finally, it should be noted that, the above embodiments are merely for describing and not intended to limit the technical solutions of the present disclosure. Although the disclosure has been described in detail with reference to the above embodiments, those of ordinary skill in the art should understand that, they can still make modifications to the technical solutions recited in the above embodiments or make equivalent replacements to a part of the technical features thereof; and the modifications or replacements do not cause essence of the corresponding technical solutions to depart from the spirit and scope of the technical solutions of the embodiments of the present disclosure.

What is claimed is:

1. An integrated photonic chip system for distributed secure quantum information processing, comprising a server integrated photonic quantum chip and a client integrated photonic quantum chip, wherein the server integrated photonic quantum chip and the client integrated photonic quantum chip are connected through a high-dimensional quantum channel;
the server integrated photonic quantum chip comprises:
a configurable entangled multi-photon source, comprising a configurable optical network, N entangled multi-photon sources, and a wavelength division multiplexer, wherein N is a natural number, and N≥2; by configuring a first phase shifter and a second phase shifter in the interference regulation network to perform interference regulation on a light beam input to the interference regulation network and output a plurality of paths of light, a plurality of path entangled photons are generated by the entangled multi-photon sources; the number of the entangled photons generated by each entangled multi-photon source is recorded as P; and the wavelength division multiplexer is configured to respectively output, according to wavelengths, the plurality of photons outputted by the configurable entangled multi-photon source to a server linear optical network and the client integrated photonic quantum chip;
the server linear optical network comprises:
an initial state preparation linear optical network O, connected to the wavelength division multiplexer, formed into corresponding O₁, O₂, . . . , O_{P-1} according to the wavelengths of the photons outputted by the wavelength division multiplexer, and configured to prepare an initial state for the photons outputted by the configurable entangled multi-photon source;
a unitary operator configuration linear optical network U, correspondingly connected to the initial state preparation linear optical network O, and configured to acquire a linear term coefficient, perform unitary transformation and linear combination, and perform beam combination, recording as U₁⁽ⁱ⁾, U₂⁽ⁱ⁾ . . . U_{P-1}⁽ⁱ⁾ (i=1, 2, . . . N); and
a projective measurement linear optical network T, correspondingly connected to the unitary operator configuration linear optical network U, and configured to perform projective measurement on a photonic quantum state after beam combination, recording as T₁, T₂, . . . , T_{P-1}; and
the client integrated photonic quantum chip comprises a coefficient configuration linear optical network C, which is connected to the wavelength division multiplexer, and configured to encode paths of the photons outputted by the wavelength division multiplexer, so as to obtain the linear term coefficients, which are recorded as α₁, α₂, . . . , α_{N}, and transmit the linear term coefficients through quantum teleportation, to perform linear combination on each item of unitary transformation in the unitary operator configuration linear optical network, so as to obtain a final quantum state result: (Σᵢ₌₁^{N}αᵢU₁⁽ⁱ⁾⊗U₂⁽ⁱ⁾⊗ . . . U_{P-1}⁽ⁱ⁾)O₁⊗O₂⊗ . . . O_{P-1}|0 [symbol] .

2. The integrated photonic chip system for distributed secure quantum information processing according to claim 1, wherein the initial state preparation linear optical network, the unitary operator configuration linear optical network, the projective measurement linear optical network, and the coefficient configuration linear optical network all belong to universal linear optical networks.

3. The integrated photonic chip system for distributed secure quantum information processing according to claim 1, wherein the configurable entangled multi-photon source, the initial state preparation linear optical network, the unitary operator configuration linear optical network, the projective measurement linear optical network, and the coefficient configuration linear optical network all achieve path encoding through the first phase shifter and the second phase shifter.

4. The integrated photonic chip system for distributed secure quantum information processing according to claim 1, wherein the interference regulation network of the configurable entangled multi-photon source comprises a log₂ N-level Mach-Zehnder interferometer, which is arranged in the form of a binary tree, that is, each output port of the previous level Mach-Zehnder interferometer is connected to an input port of the next level Mach-Zehnder interferometer, and a 2^{┌log}^{₂}^{N┐}th output port of the last level Mach-Zehnder interferometer is connected to a second phase shifter and one entangled multi-photon source; and the Mach-Zehnder interferometer comprises one first phase shifter and two multimode interferometers connected to the first phase shifter.

5. The integrated photonic chip system for distributed secure quantum information processing according to claim 4, wherein the first phase shifter and the second phase shifter adjust each path of light by means of external classical control signals, and enable the phase of each path of light before reaching the configurable entangled multi-photon source to be zero.

6. The integrated photonic chip system for distributed secure quantum information processing according to claim 1, wherein the configurable entangled multi-photon source generates the photons with P wavelengths; and the photons with one wavelength are routed to the client integrated photonic quantum chip, and the photons with another P−1 wavelength are respectively correspondingly routed to P−1 groups of initial state preparation linear optical networks, wherein P is a natural number, and P≥2.

7. The integrated photonic chip system for distributed secure quantum information processing according to claim 1, wherein the initial state preparation linear optical network comprises a multi-level chain structure.

8. The integrated photonic chip system for distributed secure quantum information processing according to claim 1, wherein the unitary operator configuration linear optical network is a triangularly-distributed optical network structure.

9. The integrated photonic chip system for distributed secure quantum information processing according to claim 1, wherein the projective measurement linear optical network comprises an inverted tree structure.

10. The integrated photonic chip system for distributed secure quantum information processing according to claim 6, wherein there are N initial state preparation linear optical networks in each of the P−1 groups of initial state preparation linear optical networks; correspondingly, the unitary operator configuration linear optical networks are divided into P−1 groups, and each group has N unitary operator configuration linear optical networks; there are P−1 projective measurement linear optical networks; and each group of unitary operator configuration linear optical networks is correspondingly connected to one group of initial state preparation linear optical networks and one projective measurement linear optical network.

11. The integrated photonic chip system for distributed secure quantum information processing according to claim 1, wherein the coefficient configuration linear optical network in the client integrated photonic quantum chip is a simplified triangularly-distributed optical network structure.
